(19) United States
(12) Patent Application Publication
(10) Pub. No.: US 2010/0231699 A1
(43) Pub. Date: Sep. 16, 2010

(54) 3D VIDEO SCREEN WITH POLARIZED PANEL

(75) Inventors: Bassam D. Jalbout, Quebec (CA); Brian Wong, Kirkland (CA)

Correspondence Address: McDermott Will & Emery, 600 13th Street, NW, Washington, DC, 20005-3096, US

(73) Assignee: LSI Industries, Inc., Cincinnati, OH (US)

(21) Appl. No.: 12/605,776

(22) Filed: Oct. 26, 2009

Related U.S. Application Data
(60) Provisional application No. 61/158,838, filed on Mar. 10, 2009.

(51) Int. Cl. H04N 13/04; G09G 3/28; G09G 3/36; G09G 3/32

(52) U.S. Cl. 348/57; 348/58; 345/60; 345/87; 345/82; 348/E13.075

(57) ABSTRACT

Screens for three-dimensional (3D) viewing are described that can include a plurality of light sources used as a video screen in conjunction with a switching polarization filter or panel. The polarization panel can be used to synchronize the left and right views interleaved on the screen. Separate left and right video signals can be interleaved into a single continuous digital video signal, for example a DVI signal, which can be displayed by the video screen. By switching the polarization panels in front of the video screen in synchronization with the interleaved data, the images can be directed to the left and right eye of a viewer. A processor can be used to accomplish the interleaving of the signals while providing the necessary synchronization signal for the polarizing screen. Related methods are also described. The light sources can include LEDs, plasma screen, LCD screen, and spatially discrete sub groups of such.

### RELATED APPLICATION

This application claims the benefit of U.S. Provisional Patent Application No. 61/158,838 filed 10 Mar. 2009, and entitled “3D Screen with Modular Polarized Pixels”, the entire contents of which are incorporated herein by reference.

### BACKGROUND

Generally, conventional video screens are constructed by providing at least one planar surface to emit or reflect light that can be seen as an image by a viewer. Three types of conventional video screens are light emitting diode (LED), plasma discharge, and liquid crystal display (LCD) screens. Typically, these video screens include multiple light sources for displaying pixels of digital images. The screens can have various resolution, too, for the horizontal and vertical axes. In color applications, the light sources often combine red, blue, and green lights the light from which is mixed to provide color for each pixel. The pixels are grouped together to form a screen which can be capable of presenting text, graphics, images, and videos to a viewer. LEDs have been used to make both large and small screens that have found use in both indoor and outdoor applications. Such approaches can be limited by size and are not easily used to produce three-dimensional (“3D”) effects for people observing the screens.

Three-dimensional (“3D”) movies are usually projected from two projectors simultaneously, one projector each for the left eye and right eye view. Each projector is equipped with a linear polarizer, but orthogonally set (i.e., cross polarized) relative to the other projector. By wearing polarized eyeglasses, with the left and right eye each set differently, and each aligned to its intended projected signal, each eye sees only the view intended for that eye. That is, the incorrectly polarized image for the other eye is cross polarized, and therefore not visible. Conventional self illuminating display screens that are used to display 3D images divide the screen into sub areas, half of which are covered by linear polarization filters in one direction, and the other half covered by linear polarization filters orthogonally oriented from the first half. The effect is a 3D image similar to the projected method, except that the definition, because of the sub area divisions in this conventional approach, is ½ that of a similar non-3D screen.

While these techniques may provide 3D viewing, the perceived resolution of the observed movie is less than ideal. Thus, a need exists to improve the resolution of 3D movies and also to provide screen for such improved-resolution 3D movies.

### SUMMARY

The present disclosure addresses the limitations noted previously, and is directed to techniques, including systems, methods, and apparatus that can be used for 3D effects for images on one or more display screens that each include a plurality of light emitting elements (or, pixels) and are each used in conjunction with a polarizing panel. The polarization panels can provide selective polarization for each display screen. Embodiments of the present disclosure can utilize an electronically switching polarized screen rather than sub dividing, so that the resolution and definition remains at the full pixel count of the screen. Different images, for example, left and right images, can be merged into a single data stream to be time multiplexed into the different images (e.g., left and right images).

Embodiments of the present disclosure can include a video screen, which is capable of 3 Dimensional (3D) viewing, when used in conjunction with a switching polarizing panel used to synchronize the left and right views that are time interleaved (i.e., time multiplexed) on the screen. Separate Left and Right Video signals can be interleaved into a single continuous signal, such as a digital video signal of suitable format. Exemplary embodiments can utilize a LED screen (or group of LEDs configured in a desired topography). The signal can then displayed by the LED screen. By switching the polarization output of a polarization panel in front of the LED screen in synchronization with the interleaved data, the images can be directed to the left and right eye of a viewer. A processor can accomplish the interleaving of the signals while providing the necessary synchronization signal for the polarizing screen.

Other embodiments can include a video screen having LCD or plasma active lighting, instead or in conjunction with a LED video screen. Where the active lighting is LCD, the embodiment can be constructed more simply, leaving out the first layer of linear polarization, since the LCD lighting is already polarized.

One skilled in the art will appreciate that embodiments and/or portions of embodiments of the present disclosure can be implemented in/with computer-readable storage media (e.g., hardware, software, firmware, or any combinations of such), and can be distributed over one or more networks. Steps described herein, including processing functions to derive, learn, or calculate formula and/or mathematical models utilized and/or produced by the embodiments of the present disclosure, can be processed by one or more suitable processors, e.g., central processing units (“CPUs) and/or graphics processing units (“GPUs”) implementing suitable code/instructions in any suitable language (machine dependent on machine independent).

Additionally, embodiments of the present disclosure can be embodied in signals and/or carriers, e.g., control signals sent over a communications channel. Furthermore, software embodying methods, processes, and/or algorithms of the present disclosure can be implemented in or carried by electrical signals, e.g., for downloading off of the Internet. While aspects of the present disclosure are described herein in connection with certain embodiments, it should be noted that variations can be made by one with skill in the applicable arts within the spirit of the present disclosure.

Other features will be apparent from the description, the drawings, and the claims.

### BRIEF DESCRIPTION OF THE DRAWINGS

Aspects of the disclosure may be more fully understood from the following description when read together with the accompanying drawings, which are to be regarded as illustrative in nature, and not as limiting. The drawings are not necessarily to scale, emphasis instead being placed on the principles of the disclosure. In the drawings:

FIG. 1 depicts a diagrammatic view of a LED video screen used in conjunction with a polarizing screen that can be switched between two different states, in accordance with exemplary embodiments of the present disclosure;

FIG. 2 depicts a diagrammatic view of a larger scale LED screen, compared to the embodiment of FIG. 1, used in conjunction with a matrix of polarizing panels, and a related synchronizing signal line, in accordance with exemplary embodiments of the present disclosure;

FIG. 3 depicts a diagrammatic view of resulting polarization status of light from a LED screen when a related polarizing screen is in each of the two states, in accordance with embodiments of the present disclosure;

FIG. 4 depicts polarizing glasses for wearing by a viewer to see a 3D effect afforded by a display screen, in accordance with exemplary embodiments of the present disclosure;

FIG. 5 depicts a block diagram of a Processor/Interleaver electronics unit, in accordance with exemplary embodiments of the present disclosure;

FIG. 6 depicts a block diagram of a method suitable for implementation by a Processor/Interleaver unit and/or software, in accordance with embodiments of the present disclosure;

FIG. 7 depicts a block diagram of the internal layout of a Processor/Interleaver electronics unit, in accordance with exemplary embodiments of the present disclosure;

FIG. 8 shows a timing diagram for data handling, interleaving, and display processing, in accordance with exemplary embodiments of the present disclosure;

FIG. 9 depicts a diagrammatic view of an LCD video screen used in conjunction with a polarizing screen that can be switched between two different states, in accordance with exemplary embodiments of the present disclosure;

FIG. 10 depicts a diagrammatic view of resulting polarization status of light from an LCD screen when a related polarizing screen is in each of the two states, in accordance with embodiments of the present disclosure; and

FIG. 11 depicts a LCD structure producing a linearly polarized output, in accordance with embodiments of the present disclosure.

The techniques and algorithms of the present disclosure can be capable of other and different embodiments, and details of such can be capable of modification in various other respects. Accordingly, the drawings and detailed description can be to be regarded as illustrative in nature and not as restrictive. While certain embodiments depicted in the drawings, one skilled in the art will appreciate that the embodiments depicted can be illustrative and that variations of those shown, as well as other embodiments described herein, may be envisioned and practiced within the scope of the present disclosure.

### DETAILED DESCRIPTION

The present disclosure is directed to techniques, including systems, methods, and apparatus that can be used for 3D effects for images displayed on one or more display screens having a plurality of light emitting elements (or, pixels) or by a group of such lighting elements. For these 3D effects, a polarizing screen or layer can be used to provide selective polarization for the lighting screen(s) or groups of lighting elements.

The groups of lighting elements (also referred to herein as sources or pixels) can be used to display pixels of digital images. A display screen or surface (topology) of any desired large size can be formed by appropriate configuration of the pixels. A polarizing panel can be used with a desired number of pixels, such as those of a particular video screen. The entire produced image displayed on a video screen can be visible by either eye from any direction. As a result, three-dimensional (“3D”) effects can be realized, e.g., a viewer can perceive images that appear to have a depth dimension. For some applications, multiple polarizing panels can be utilized to provide 3D effects for relatively large numbers of pixels. Embodiments of the present invention can generate images with either polarity on any pixel at any time.

The production of a 3D movie or video commonly employs the recording or filming of two views, representing the perspective of the recorded scene for the left and right eyes of a viewer. This results in two streams of video data. If the images are to be provided to a display screen, it is necessary to show both images, i.e. the left and right eye images, on the same set of pixels on the same screen. Consequently, embodiments of the present disclosure provide for the combination of two or more data streams into a single video data stream. This can be done by interleaving (e.g., alternating left and right images) the two data streams. Any suitable or standard video data format can be used. For example, DVI, HDMI, or other common digital video formats can be used. Although the following description refers to DVI signals, it is obvious that the principle of interleaving data can be accomplished with other standard formats as well.

In addition to interleaving the data streams, the resulting combined data stream can be keyed or identified as to which frames are for the one eye, and which frames are intended for the other eye of a viewer. Accordingly, the combined data stream is preferably accompanied by a second set of information in order to decode the images back into left and right eye images. In this invention, this is done by providing a separate switching signal that is used to switch polarized rotation panels between two output states, for example, states for the left and right-eye views (which may be referred to as states 0 and 1).

The interleaving can be accomplished in two different ways. In the preferred embodiment, the data rate of the combined data stream is double the data rate of the individual left and right data streams. In an alternative embodiment, the combined data stream can sample only every second frame of the two individual streams, thus maintaining the same data rate. The first method is preferred and described here, but the second method can be accomplished with the same hardware configuration, and simply modifying the software and software controlled drivers. Typically, the left and right eye images would be 60 frames per second, resulting in the combined data stream of 120 frames per second.

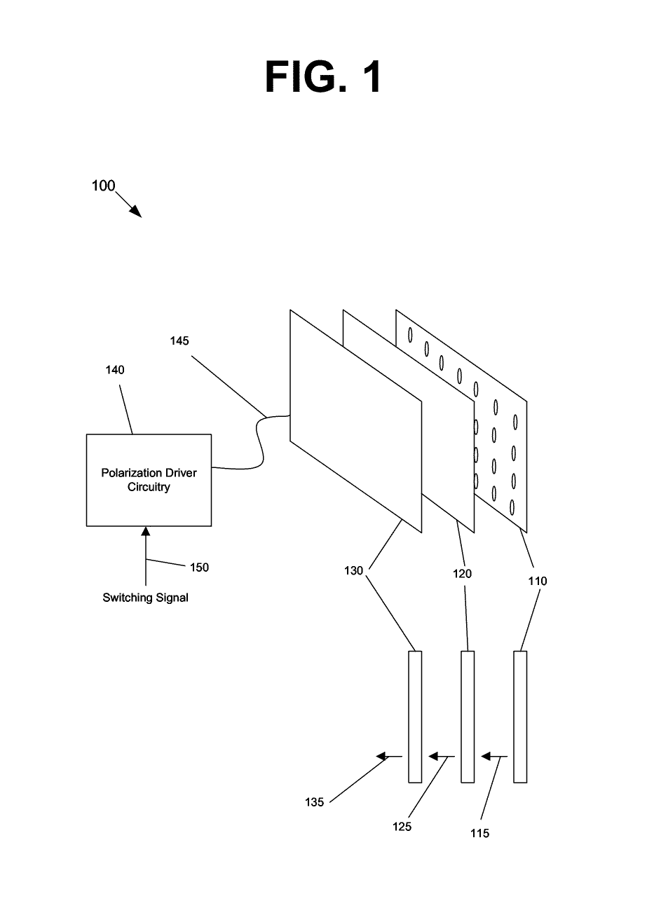

FIG. 1 depicts a diagrammatic view of a 3D viewing system 100 including a video screen used in conjunction with a polarizing screen that can be switched between two different states, in accordance with exemplary embodiments of the present disclosure.

As shown in FIG. 1, the system 100 can include three layers, a video screen (e.g., a LED display screen) 110, a linear polarizing filter 120, and an electronically switchable polarization rotator 130. The polarization rotating (or polarization switching) panel 130 has two driven states, which result in either a 90 degree rotation, or zero rotation, in the two states.

The polarization rotation panel 130 is configured to receive its drive signal through cable 145, from the electronic drive circuitry 140, e.g., as shown in detail in later drawings. The timing of the switching signal 150 can be provided by a processor, also described later. The display panel emits unpolarized light, 115. The passage of the light or image through linear polarizer 120 results in a linearly polarized image, 125. This image is then passed through the polarization rotation panel 130 either with zero rotation, or with a 90 degree rotation, depending on the state of the switching signal 150, i.e. whether it is at state 0 or state 1. It is irrelevant whether the rotation panel is a type which rotates left or right, as a 90 degree rotation results in cross polarization relative to the original image 125, in either case.

It is not necessary that the two states cause a rotation from zero to 90 degrees, only that the two states are 90 degrees different from each other. For example, the two states could cause a rotation of −45 degrees and +45 degrees, and the end result is the same; i.e. the two states result in cross polarization relative to each other (their polarization states are separated 90 degrees or π/2 radians). For example, the two states could be 10 degrees and 100 degrees, etc. In exemplary embodiments, the polarization rotation panel can include one or more liquid crystal twisted nematic polarization rotators (TN cells), e.g., as made commercially available by ARCoptix S.A. having a business location at Tros-portes 18, 2000 Neuchatel, Switzerland; other suitable polarization rotators may also be used within the scope of the present disclosure.

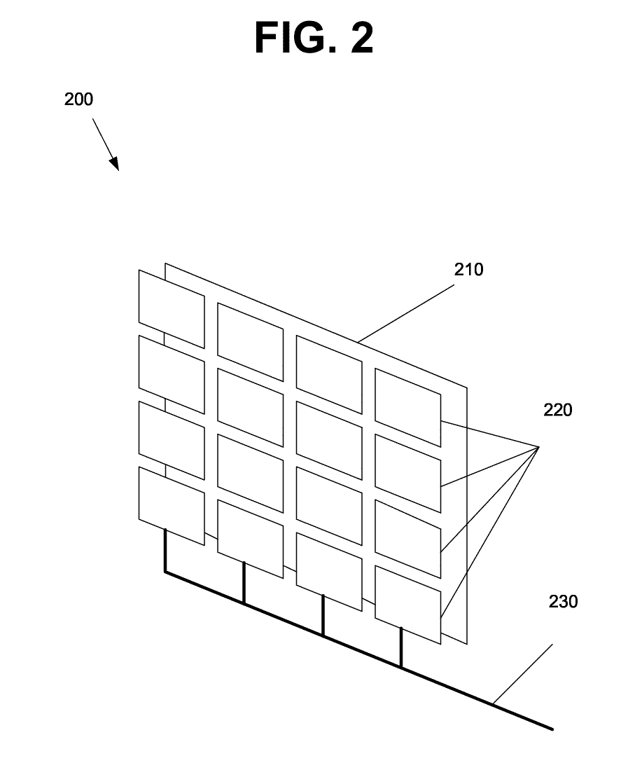

For relatively large display systems, such as large-dimension display panels covering hundreds of square feet or meters, several of the panels 120/130 can be used. An example of such a large-scale embodiment is shown in FIG. 2.

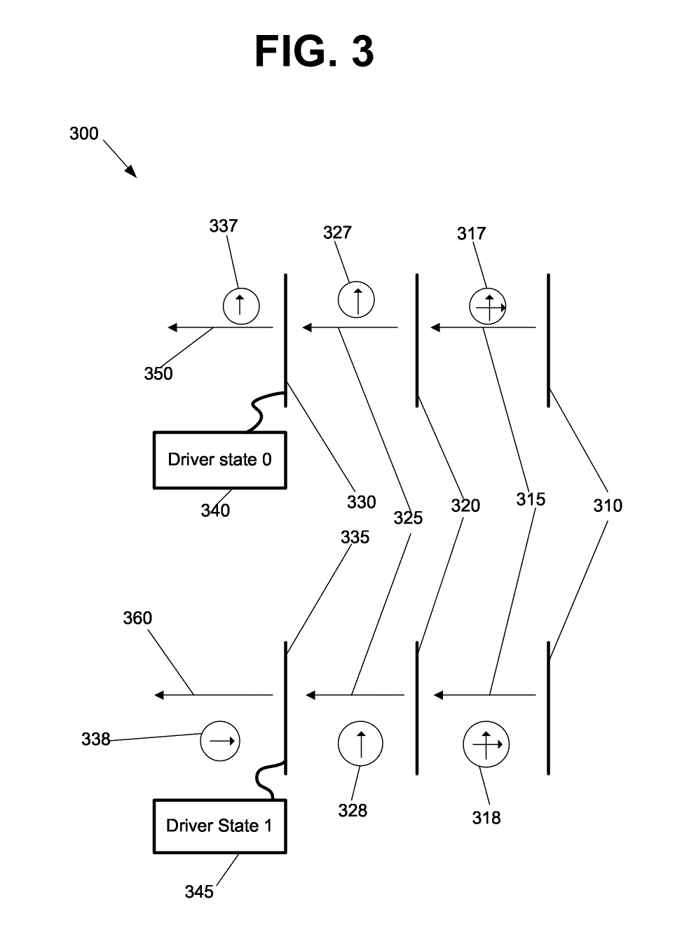

FIG. 2 depicts a diagrammatic view of a larger scale video display screen, compared to the embodiment of FIG. 1, used in conjunction with a matrix of polarizing panels, and a related synchronizing signal line, in accordance with exemplary embodiments of the present disclosure. FIG. 2 shows how a large panel 200, e.g., consisting of LED panel 210, can be turned into a 3D system by a matrix of polarization rotation panels 220, all of which are switched between the two states through the switching signal cable 230. A suitable control system can coordinate the switching of the multiple polarization rotation panels 220. Examples of the polarization output states produced by polarization rotation panels 220 are shown in FIG. 3.

FIG. 3 depicts a diagrammatic view of resulting polarization status of light from a display screen, for example a LED screen, when a related polarizing screen is in each of the two states, in accordance with embodiments of the present disclosure.

FIG. 3 shows how the change in Polarization Driver state affects the image from the LED display to the viewer. The LED display panel 310 emits non polarized light 315, as indicated by the combination of both horizontal and vertical vectors, 317 and 318. Polarizing filter 320 is in the light path of 315, so that when the image emerges 325, it is restricted to a single vector as indicated by vertical vector 327 and 328. The image must then pass through the polarization rotator, which is represented by 330 when the driver is in state 0, and by 335 when the driver is in state 1.

With continued reference to FIG. 3, the driver in state zero does not rotate the linearly polarized light 325, so that it emerges essentially unchanged as 350, which remains polarized as indicated by the vector 337, the same polarization vector as 327. However, when in state 1, the polarization rotator 335 rotates the light by 90 degrees, so that image 325 emerges rotated as 360, which now has a horizontal vector, as indicated by 338. Since 350 is vertically polarized and 360 is horizontally polarized, they are essentially cross polarized relative to one another. A viewer wearing eyeglasses with vertically polarized filters would be able to see image 350, but would not be able to see image 360. Similarly, a viewer wearing eyeglasses with horizontally polarized filters would be able to see image 360, but would not be able to see image 350.

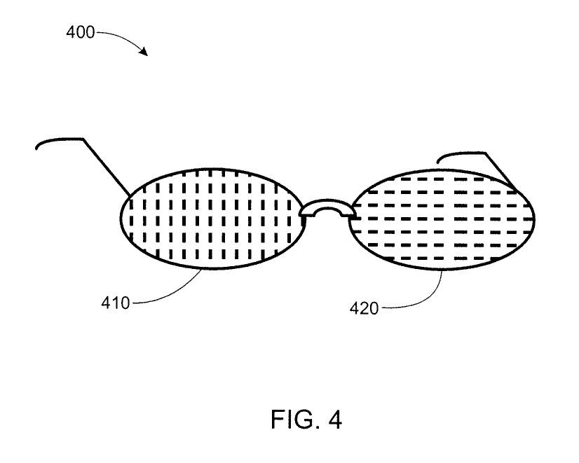

FIG. 4 depicts polarizing glasses 400 for wearing by a viewer to see a 3D effect afforded by a display screen, in accordance with exemplary embodiments of the present disclosure.

Eyeglasses 400 can have different polarizing filters for the left and right eye apertures. One of the eyes is provided with a vertically polarized filter 410, while the other eye is equipped with a horizontally polarized filter 420. The result is that the image 350 is seen by the eye with the filter 410, but not by the eye with the other filter 420. Similarly, the eye with filter 420 could see the image 360, but not the image 350. If images 350 and 360 are provided as different stereoscopic views for the left and right eye, then the viewer wearing glasses 400 can experience 3D imaging.

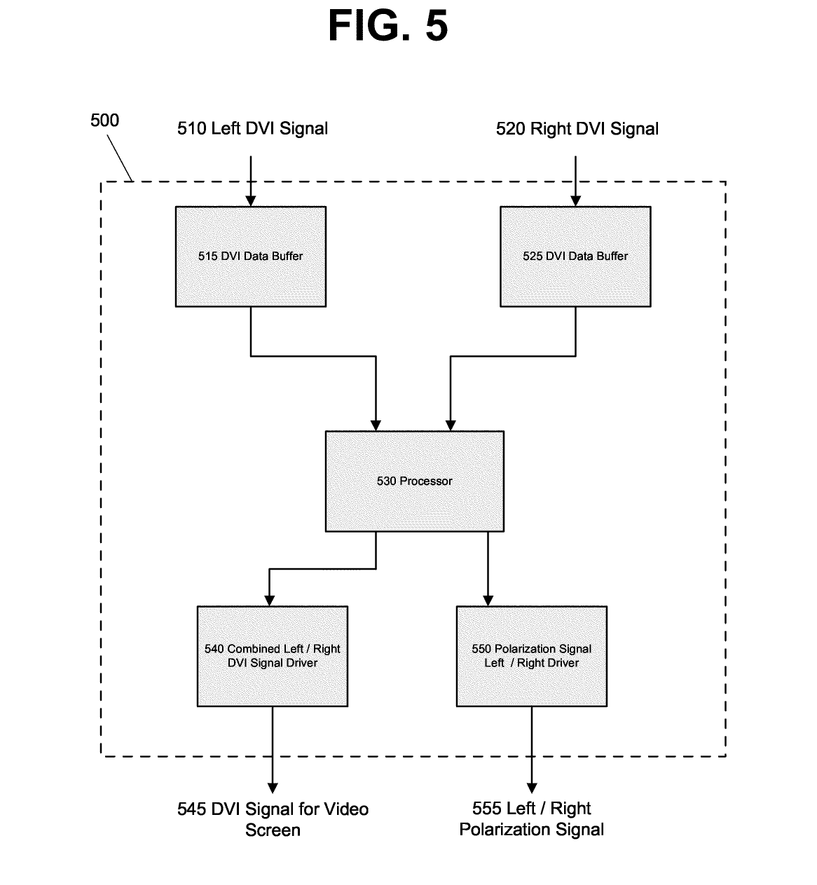

FIG. 5 depicts a block diagram of a Processor/Interleaver electronics unit, in accordance with exemplary embodiments of the present disclosure.

FIG. 5 shows a block diagram for the processor unit 500 required to perform the interleaving of the two DVI signals, and to provide a synchronising switching signal for the polarization rotator panel(s). The two separate video streams for the left eye 510 and right eye 520, are clocked into the two data buffers 515 and 525 respectively. The data are held in these buffers until offloaded by the CPU processor 530. The CPU then clocks out the combined data through buffer/driver 540, which is output as combined signal 545, while simultaneously identifying the left and right images with the two state signal 550. The driver 550 (e.g., 140 of FIG. 1) can provide the Left/Right eye polarization signal 555, which can be sent to or received by each of the polarized rotation panels 130, 220, 330, and 335.

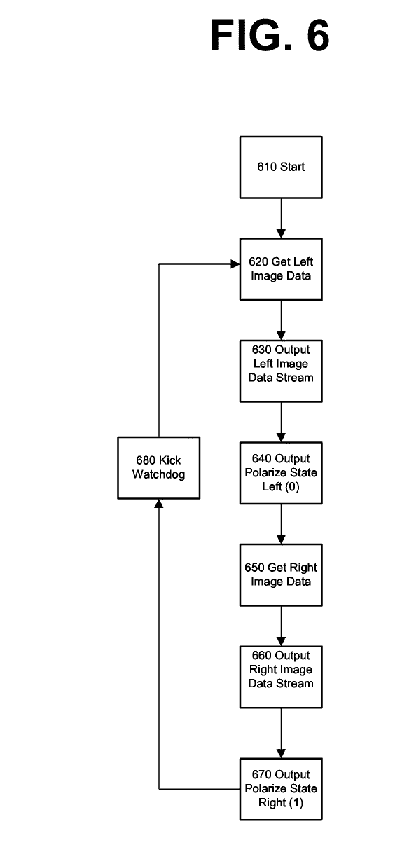

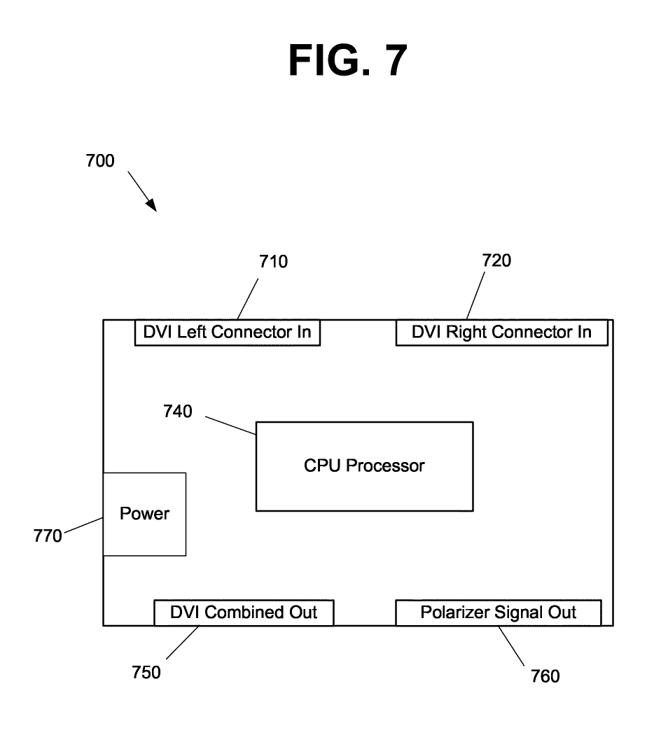

FIG. 6 depicts a block diagram 600 of a method suitable for implementation by a Processor/Interleaver unit and/or software, in accordance with embodiments of the present disclosure. A software program, e.g., implementing the functional block diagram 600, can be run by a suitable processor (such as processor 740 described for FIG. 7) in order to interleave two video data streams corresponding to the views of the left and right eyes, respectively, and to drive the polarization signal.

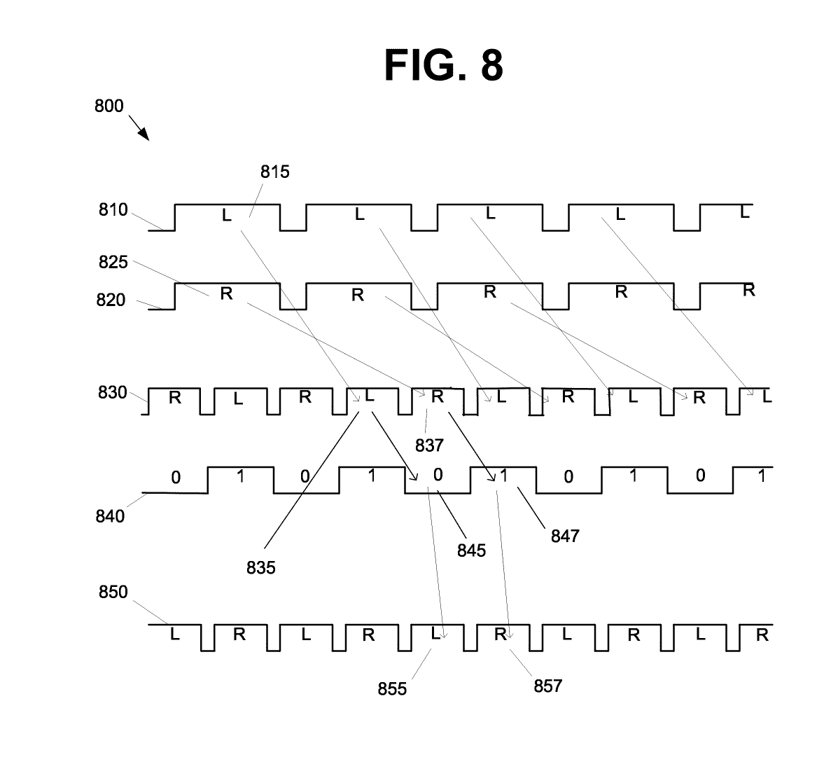

For method 600, 610 is the entry to the software loop. At 620, the buffer for one of the two eye-view images, e.g., the left eye image, is detected as complete (i.e., “buffer full”) and ready for offloading. This buffered data is offloaded into the processor memory for output as part of the combined data stream. Note that the buffer 515 clocks in and holds the left eye image data ready for the processor. Buffer 515 can be offloaded via a parallel data bus, and therefore can be very quick compared to the actual video data stream. The left data is clocked out into the combined data stream, 630. When the data block has been completely clocked out, the processor sets the polarization state into the Left (state 0) condition, 640. This process is repeated for the right eye data stream, collecting the data, 650, clocking out the right eye data into the combined data stream, 660, and then setting the polarization state to the Right condition, i.e. state 1, 670. The processor, according to method 600, can then kick a watchdog. 680, before returning to the beginning of the loop. For exemplary embodiments, such a loop can result in the timing of the signals as shown in FIG. 8.

Of course while the description of FIG. 6 is described as beginning with the left image, such is an arbitrary decision, and of course, the right-eye image can be selected for initial processing.

FIG. 7 depicts a block diagram of the internal layout 700 of a Processor/Interleaver electronics unit, in accordance with exemplary embodiments of the present disclosure.

As shown in FIG. 7, in layout 700 of the Processor/Interleaver unit (e.g., processor 500 of FIG. 5), a DVI signal for the left eye images can be connected at DVI connector 710. The DVI signal for the right eye images can be connected to the DVI connector 720. The resulting combined video image data is output at connector 750, and the Polarization signal providing the state 0 and state 1 synchronization signal output on connector 760. The CPU processor 740 controls the electronics on 700, e.g., by running the software as described for FIG. 6. Power to the board 700 is supplied through connector 770.

As described previously, a combined data stream can be keyed or identified as to which frames are for the one viewer eye, and which frames are intended for the other eye of a viewer. Accordingly, the combined data stream is preferably accompanied by a second set of information in order to decode the images back into left and right eye images. This can be accomplished by providing a separate switching signal (e.g., signals 145, 230, 340, 345 of the drawings) to switch the polarized rotation panels (e.g., panels 130, 220, 330, 335 of the drawings) between the two states left and right, i.e. states 0 and 1.

FIG. 8 shows a timing diagram 800 for data handling, interleaving, and display processing, in accordance with exemplary embodiments of the present disclosure.

As shown in FIG. 8, two data streams for the left eye 810, and right eye 820, can be presented to the processor/interleaver unit 500, 700, as DVI data at 710 and 720 respectively. The DVI data for the left eye is clocked in during the period designated 815 or L. Note that this part of the square wave 810 represents the timing of the DVI signal, and not the DVI data itself. Similarly, 825 represents the period of time when the right eye DVI signal is clocked into the processor/interleaver unit. Note that although 810 and 820 appear to be synchronous in this diagram, they are not required to be, nor would they normally would be. Line 830 represents the timing for the clocking out of the combined data stream 545, 750. Line 840 represents the state of the polarization driver at 555, 760. Line 850 represents the timing of images displayed by the LED display board, 210.

After a complete frame of the left eye has been clocked in by the data buffer 515, the processor executes software 620, in preparation for output. The processor then executes 630, which clocks out the left eye data, resulting in the data collected at 815 being output during time 835. The processor then sets the polarization state into 0 or the left condition, 640. This results in the polarization driver line 840 switching to the low condition, at time 845. Within time period 845, the left eye image is output by the LED display board, 855, which has recognised that it has received a full buffer image at the end of period 830, and outputs the clocked image during the time periods indicated by 850. Note that the LED display does not know whether the image received is a left eye or right eye image; the change in polarization state causes the polarization panels to automatically sort out the left/right configuration.

The processor then continues with the right eye sequence of instructions, e.g., 650, 660, which results in the buffer collecting and offloading of the right eye image, 825, and the clocking out of that data during 837. Step 670 causes the setting of the polarization into the high state, e.g., state (1) at time 847, and the LED display board emits the right eye image during 857.

The loop can then restart with the left eye data, and the entire process can be repeated. The result is the time multiplexed combined data stream as represented by 830, synchronised and separated into individual left and right eye images by 840. Note that 840 is delayed relative to 830, which in turn is delayed relative to 810 and 820, due to the buffer clocking time, e.g., according to the nature of serial data streams, meaning that the timing can be dependent on the end or last data bit of a data stream.

A viewer wearing glasses, e.g., glasses 400 of FIG. 4, can have a specifically oriented polarized filter (e.g., vertically) in the viewing aperture in front of his or her left eye, 410, and an oriented polarized filter of crossed polarization (e.g., horizontally) in the viewing aperture in front of the right eye 420. Thus when the polarization signal is in state 0, 340,845, the image 350, 835, vertically polarized, is emitted, and because it is in the same polar orientation as the left eye, allowing the image 350 to be seen by the left eye, while that same image 350 is cross polarized relative to the filter 420 over the right eye, thus blocking the image 350 from the right eye. Similarly, when the polarization signal is in state 1, 340,847, the image 360, horizontally oriented, is emitted, and since it is in the same polar orientation as the right eye, allowing the image 360 to be seen by the right eye, while that same image 360 is cross polarized relative to the filter 410 over the left eye, thus blocking the image 360 from the left eye. Of course, the oriented polarization filters provided to the left and right viewing apertures of such glasses (e.g., 400) can be of any orientation with the proviso that the filters are cross-polarized (or substantially so) with respect to one another. In other words, it is preferable that the filters are configured such that the polarization orientation of the separate filters is 90 degrees (or about 90 degrees) with respect to one another and so long as they correspond to the two emitted polarization angles of the embodiment.

Thus a viewer wearing glasses 400 would experience seeing the left image screen exclusively with his or her left eye, and simultaneously seeing the right image exclusively with his or her right eye, producing the 3D effect. The image refresh rate can be 120 per second (e.g., 60 Hz at each eye), which is sufficiently faster than the persistence of vision effect (e.g., slower than 30 per second) so that there is no flicker effect. Note also that by interleaving the two data streams, the refresh rate of the original individual data streams is maintained to both eyes.

As described previously, it should be noted that although for this embodiment, vertical polarization has been used for the left eye, and horizontal polarization for the right eye, in fact any pair of cross polarization configurations would work, for example −45 degrees for the left eye, and +45 degrees for the right eye, so long as the images are created in that same orientation pair.

For embodiments where LCD construction is used for the pixel source, i.e. 110,310, there is no requirement for the first linear polarizer layer, i.e. 120, 320. This is due to the property of the LCD emitters, which are already linearly polarized.

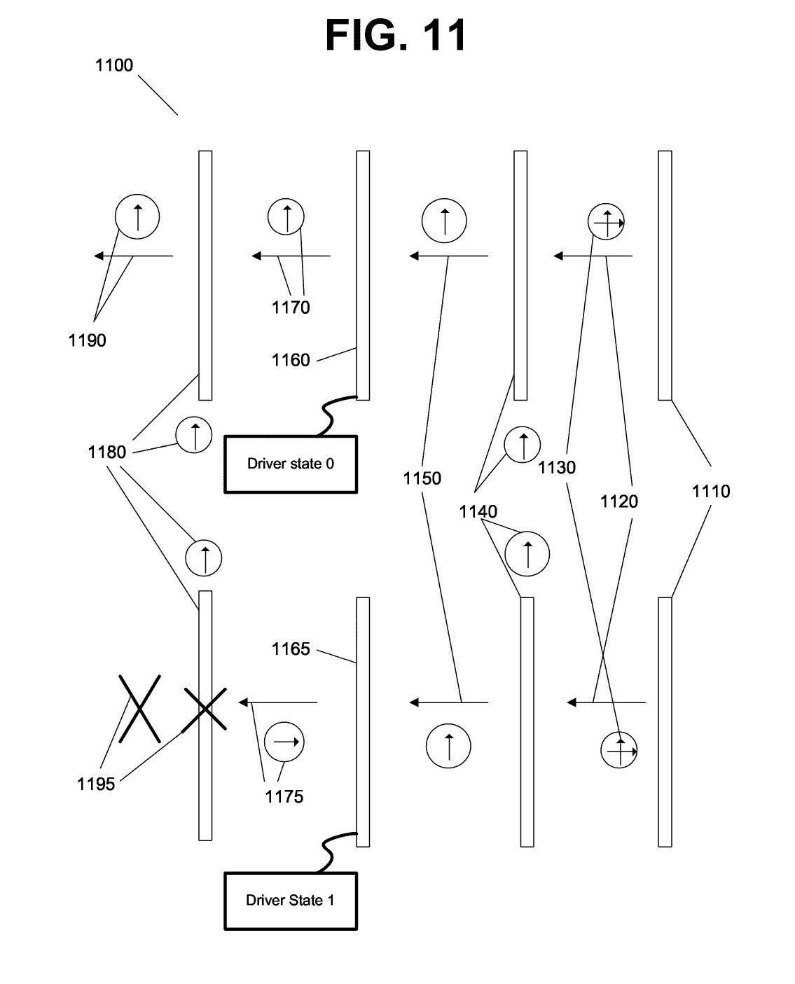

FIG. 11 depicts a LCD structure producing a linearly polarized output, in accordance with embodiments of the present disclosure. There is a light source, 1110, which can sometimes be a LED, fluorescent, plasma, or even incandescent light source. This source 1110, is non polarized, as indicated by the light emission 1120 having both horizontal and vertical vectors, 1130. The LCD cell typically follows this with a linear polarizer layer 1140, which has a vector, say for example vertical, as indicated. This results in a linearly polarized light 1150, with a vertical component, 1150. This is followed by a polarization rotator layer 1160, 1165, which can be switched into the two driver states, 0 or 1, resulting in zero rotation by 1160, and 90 degree rotation by 1165. Thus the emerging light from layer 1160, 1165 can be either vertical, 1170, or horizontal, 1175. This is followed by a layer 1180, which is a linear polarizing layer the same as 1140. In the case where the light has not been rotated, 1170, the light can pass through layer 1180 easily, resulting in a bright emission, 1190. Where the light has been rotated 90 degrees, 1175, the light is cross polarized 1195, with respect to layer 1180, and thus is blocked, 1195, resulting in virtually no visible light emission. Thus the light 1190 emerging from the LCD cell has a linearly polarized property, and thus layer 120,320 are not required in an embodiment using LCD type light pixels. Some variations of LCD construction have layer 1180 cross polarized with respect to layer 1140; this results in the two driver states 0 and 1 being dark and light, respectively, instead of light and dark.

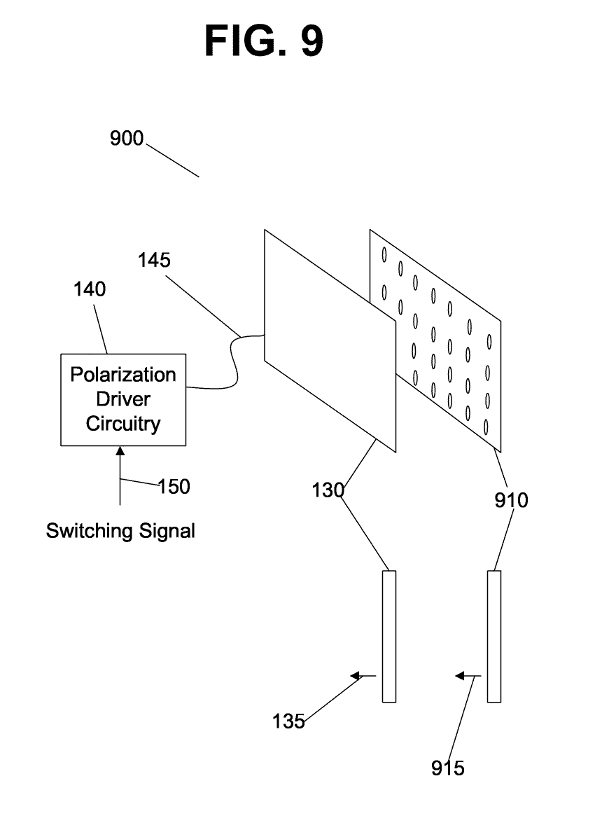

FIG. 9 shows the variation of this invention using LCD type pixels 910. In comparison with FIG. 1, note that layer 120 is removed, Since LCD light emission 915 is already polarized, it is equivalent to light at 125. The rest of the construction, layers 130 and the switching signals 145, remain the same as for LED type pixels.

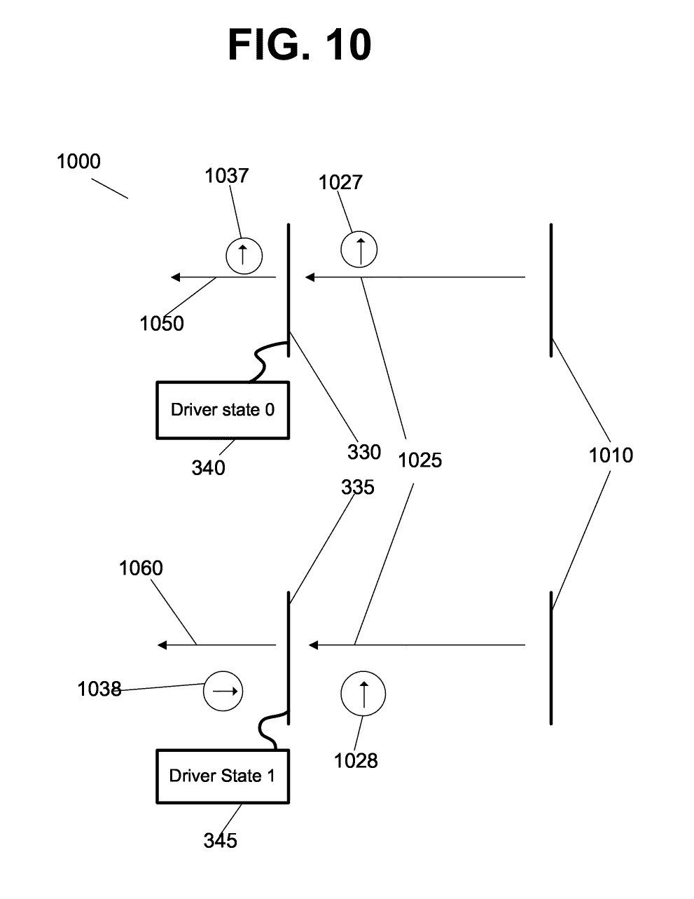

FIG. 10 shows how the LCD type pixels 1010 emit polarized light, 1025, 1027, equivalent to 325, 327 of FIG. 3, and thus not requiring layer 320. The remaining construction, layer 330, 335, and driver signals 340, 345, remain the same as for LED type pixels. Thus the light emerging from LCD type pixels, 1050, 1060, are equivalent in polarization property as 350, 360, in that the polarization vectors 1037, 1038, are the same as for the LED type pixels, 337, 338 respectively.

A number of exemplary implementations and examples have been described. Nevertheless, it will be understood that various modifications may be made. Suitable results may be achieved if the operations of described techniques can be performed in a different order and/or if components in a described system, architecture, device, or circuit can be combined in a different manner and/or replaced or supplemented by other components. For example, various light sources may be used and orientation of devices may be changed.

Accordingly, the above described examples and implementations can be illustrative and other implementations not described can be within the scope of the present disclosure. Moreover, the following claims can be by way of example and do not define the scope of the present disclosure.

What is claimed is:

1. A 3D Video Screen system comprising:
a video display including a plurality of light sources;
a linear polarizing filter configured and arranged to filter light emitted from the video display; and
an electronically switchable polarization rotator configured and arranged to filter light emitted from the video display, wherein the polarization rotator is configured and arranged to produce two driven polarization output states that are about 90 degrees rotation relative to one another.

2. The system of claim 1, wherein the polarization rotator includes a layer of twisted nematic liquid crystals.

3. The system of claim 1, wherein the video display comprises a video display screen.

4. The system of claim 1, wherein the video display comprises a support lattice configured and arranged to hold the plurality of light sources.

5. The system of claim 1, wherein the video display comprises a plurality of LEDs.

6. The system of claim 3, wherein the display screen comprises a plasma screen.

7. The system of claim 3, wherein the display screen comprises a LCD screen.

8. The system of claim 1, wherein the polarization rotator includes a plurality of polarization rotation screens configured so as to selectively filter the output from respective separate groups of the plurality of light sources.

9. The system of claim 9, further comprising a viewing device for a viewer, wherein the viewing device comprises a first viewing aperture and a second viewing aperture, each including a polarized filter that is polarized at about 90 degrees to the material of the other viewing aperture.

10. The system of claim 9, further comprising a controller configured and arranged to receive an interlaced control signal having image information for separate views corresponding to the left and right eyes of a viewer, respectively.

11. The system of claim 10, wherein the controller is further configured and arranged to switch the output states of the switchable polarization rotator.

12. The system of claim 10, wherein the controller is configured and arranged to produce a control signal for the switchable polarization rotator including a timing signal.

13. The system of claim 12, wherein the control signal conforms to digital video format.

14. The system of claim 13, wherein the digital video format is DVI.

15. A method of controlling a video display for creating a 3D effect, the method comprising:
receiving a data stream for a left eye image;
receiving a data stream for a right eye image;
combining both data streams into a combined data stream;
providing a timing signal to the combined data stream, wherein the timing signal is keyed to the respective eye images in the combined data stream;
providing the combined data stream to a plurality of light sources for displaying images;
switching a polarization rotator between two driven output states based on the timing signal; and
filtering, by polarization, the output from the plurality light sources so as to provide left eye images to the left eye of a viewer and right eye images to the right eye of the viewer.

16. The method of claim 15, further comprising providing to a viewer a pair of viewing glasses configured and arranged to provide light having one of the two polarization states to the left eye of the viewer and light having the second of the two polarization states to the right eye of the viewer.

17. The method of claim 16, wherein the first polarization state corresponds to light having a first polarization and the second polarization state corresponds to light having a substantially orthogonal polarization.

18. The method of claim 15, wherein the plurality of light sources comprises a plurality of LEDs.

19. The method of claim 15, wherein the plurality of light sources comprises a LCD screen.

20. The method of claim 15, wherein the plurality of light sources comprises a plasma screen.

21. The method of claim wherein the combined data stream includes a DVI signal.

22. A computer program product residing on a computer-readable storage medium having a plurality of instructions stored thereon, which when executed by a processing system, cause the processing system to:
receive a data stream for a left eye image;
receive a data stream for a right eye image;
combine both data streams into a combined data stream;
provide a timing signal to the combined data stream, wherein the timing signal is keyed to the respective eye images in the combined data stream;
provide the combined data stream to a plurality of light sources for displaying images;
switch a polarization rotator between two driven output states based on the timing signal; and
filtering, by polarization, the output from the plurality light sources so as to provide left eye images to the left eye of a viewer and right eye images to the right eye of the viewer.

23. The computer program product of claim 22, wherein the computer-readable storage medium comprises flash memory.

24. The computer program product of claim 22, wherein the computer-readable storage medium comprises RAM.
